(19) United States
(12) Patent Application Publication
(10) Pub. No.: US 2005/0044502 A1
(43) Pub. Date: Feb. 24, 2005

(54) Arrangements and methods for visually indicating network element properties of a communication network

(76) Inventor: Jennifer Jie Fu, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/644,948

(22) Filed: Aug. 19, 2003

(51) Int. Cl. G09G 5/00; G06F 15/173

(52) U.S. Cl. 715/734; 715/736; 715/737; 715/738; 715/713; 715/853; 709/223; 709/224

(57) ABSTRACT

A method for displaying a communication network in a graphical user interface (GUI) display is disclosed. The method includes displaying at least a portion of the communication network in the GUI display, including a plurality of network element icons representing a plurality of network elements and logical connections among the plurality of network element icons. The method further includes ascertaining a first set of properties associated with a first network element of the plurality of network elements, the first set of properties representing properties associated with the first network element in the communication network. The method additionally includes displaying at least one visual indicator in the GUI display, the at least one visual indicator being displayed in a visually connected manner with a first network element icon representing the first network element, the at least one visual indicator visually indicating in the GUI display that the first set of properties is associated with the first network element in the communication network.

### BACKGROUND OF THE INVENTION

Computer networks are pervasive these days. In a typical computer network, devices of different types are interconnected via switching elements, such as routers, switches, and hubs, to allow the devices to communicate among one another according to a predefined communication model.

There are various ways in which networks can be configured into topologies required by applications using those networks. The simplest network tends to involve hardwiring the various devices together using appropriate switching elements and interconnecting media (e.g., conductive cables, fiber optic cables, the wireless medium, etc.). Although the hardwire approach works well for relatively small, static network configurations, it does not scale well and tends to result in networks that are difficult to manage and upgrade.

Recently, there has been proposed a more flexible approach to building computer networks. Instead of constructing each network topology piecemeal by hardwiring the devices together, the devices are viewed as belonging to a common pool of resources. In some cases, the devices are disposed in a hierarchical tree topology. A hierarchical tree topology is used since devices in the tree communicate among themselves along deterministic communication paths, thereby simplifying the provisioning and upgrade tasks. Within the hierarchical tree topology, the devices are then interconnected using a pool of switching elements. Depending on how the switching elements are configured, various logical networks can be constructed from this common pool of devices and switching elements (e.g., switches, routers, and hubs) using, for example, a virtual local area network (VLAN) technology. A discussion of one exemplary VLAN technology may be obtained from the IEEE 802.1 Q working group (http://grouper.ieee.org/groups/802/1/, September 2002)

Under this approach, any number of logical network topologies can be constructed from the physical network if there are sufficient resources in the common pool of network elements (i.e., devices and switching elements such as switches, routers, and hubs).

Consider the following example. An organization may wish to create or upgrade to a three-tier application topology having two database servers, five application servers, four web servers, and a firewall for Internet access. From this specification and the communication model, which governs the communication policy (including the expected bandwidth usage) for each device required for the application, the necessary devices (e.g., database servers, application servers, web servers, and firewalls) may be picked from the common pool of devices and interconnected using the switching elements in the tree.

Thus, the construction of a logical network topology becomes an exercise in selecting and/or configuring the required devices from the pool of available devices existing in the tree hierarchy and selecting and/or configuring the switching elements appropriately to interconnect the devices as specified by the communication model and the logical specification.

The tasks of selecting and/or configuring the devices and switching elements (collectively “network elements”) are typically accomplished by an operator using an appropriate control console. Using an appropriate control software, e.g., a network configuration portal, the operator may select the required network element icons (e.g. device icons and switching element icons). For example, certain network configuration portal may include a graphical user interface (GUI) to allow the operator to drag-and-drop or otherwise select the required network element icons.

The operator may further configure the required network elements with the desired properties. For example, load balancers may be associated with different properties, including the specific policy for balancing (e.g., round robin, least connectivity, etc.) Likewise, properties for application/database servers may include, among others, the type of server, backup frequency, etc. Properties for subnets may include, among others, whether the subnet is publicly routable, whether the subnet is in a specific group, etc. Properties for firewalls may include, among others, the brand and software, ACL (Allow Access), etc. Properties for virtual private networks (VPNs) may include, among others, protocol (PAP, CHAP, EAP, etc.). Properties for connections may include, among others, type (co-axial, twisted pair, wireless, fiber optic, etc.), the allowed bandwidth, the carrier frequency, and the like.

With a GUI-based network configuration portal, the configuration task for a network element may be accomplished by, for example, right-clicking on each network element icon. Right-clicking on a network element icon allows the operator to view the properties of that selected network element, and the operator may then change any of the properties associated with a network element if desired. Once the operator de-selects a network element icon, e.g., by selecting another network element icon to view its properties, the properties of the newly selected network element icon are displayed for viewing and/or modification, and the properties associated with the previously selected network element icon become hidden from view. Thus, by toggling among different network element icons, the operator can ascertain the properties associated with various network elements of the newly constructed logical network.

While such approach may be workable for relatively small networks, e.g., those with only a few network elements, the task loading on the operator increases dramatically for larger networks. For example, if an error is reported and the operator needs to quickly ascertain whether any of the network elements has been improperly configured with the incorrect properties, the operator may need to toggle among different network element icons to view their properties until the problem is found. To an impatient customer waiting for the logical network to be repaired quickly, such a time-consuming approach is unacceptable.

Furthermore, during the initial configuration phase, the properties that can be associated with a network element may depend on the properties accorded to other network elements that affect it. For example, the properties to be associated with a virtual private network (VPN) may depend on the properties accorded to the servers and computers connected to that VPN. Using the prior art GUI-based network configuration portal, the operator must take note and/or remember the properties associated with other network elements while configuring up a given network element. If the operator does not remember, he has to double-click on one or more of the other network element icons to ascertain their properties in order to allow him to properly configure the given network element. The lack of user-friendliness and the cumbersome manner with which configuration is performed using the prior art GUI-based network configuration portal increases the chance for errors as well as the time it takes to configure a logical network.

### SUMMARY OF INVENTION

These and other features of the present invention will be described in more detail below in the detailed description of the invention and in conjunction with the following figures.

The invention relates, in one embodiment, to a method for displaying a communication network in a graphical user interface (GUI) display. The method includes displaying at least a portion of the communication network in the GUI display, including a plurality of network element icons representing a plurality of network elements and logical connections among the plurality of network element icons. The method further includes ascertaining a first set of properties associated with a first network element of the plurality of network elements, the first set of properties representing properties associated with the first network element in the communication network. The method additionally includes displaying at least one visual indicator in the GUI display, the at least one visual indicator being displayed in a visually connected manner with a first network element icon representing the first network element, the at least one visual indicator visually indicating in the GUI display that the first set of properties is associated with the first network element in the communication network.

In another embodiment, the invention relates to a method for displaying a communication network in a graphical user interface (GUI) display. The method includes displaying at least a portion of the communication network in the GUI display, including a plurality of network element icons representing a plurality of network elements and logical connections among the plurality of network element icons. The method additionally includes ascertaining a first set of properties associated with a first network element of the plurality of network elements, the first set of properties representing properties associated with the first network element in the communication network. The method also includes ascertaining a second set of properties associated with a second network element of the plurality of network elements, the second set of properties representing properties associated with the second network element in the communication network. The method also includes visually indicating in the GUI display that the first set of properties is associated with the first network element in the communication network. The method also includes visually indicating in the GUI display, simultaneously with the visually indicating that the first set of properties is associated with the first network element, that the second set of properties is associated with the second network element in the communication network.

In yet another embodiment, the invention relates to an article of manufacture comprising a program storage medium having computer readable code embodied therein, the computer readable code being configured to display a communication network in a graphical user interface (GUI) display. There is included computer readable code for displaying at least a portion of the communication network in the GUI display, including a plurality of network element icons representing a plurality of network elements and logical connections among the plurality of network element icons. There is further included computer readable code for ascertaining a first set of properties associated with a first network element of the plurality of network elements, the first set of properties representing properties associated with the first network element in the communication network and for ascertaining a second set of properties associated with a second network element of the plurality of network elements, the second set of properties representing properties associated with the second network element in the communication network. There is additionally included computer readable code for visually indicating in the GUI display that the first set of properties is associated with the first network element in the communication network and for visually indicating in the GUI display, simultaneously with the visually indicating that the first set of properties is associated with the first network element, that the second set of properties is associated with the second network element in the communication network.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a prior art illustration of a logical network topology rendered in a graphical user interface (GUI) computer screen.

FIG. 2 shows, in accordance with one embodiment of the present invention, the integrated GUI control console view.

FIG. 3 is a flowchart illustrating the steps employed to configure a network element in accordance with one embodiment of the present invention.

FIG. 4 is a flowchart illustrating, in accordance with one embodiment of the present invention, the steps taken when rendering a network element icon with associated property visual indicator(s).

FIG. 5 is a table illustrating, in accordance with one embodiment, some exemplary network elements and their potential associated properties.

### DETAILED DESCRIPTION OF PREFERRED EMBODIMENTS

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

In accordance with one embodiment of the invention, there is provided a graphical user interface for displaying network element icons wherein selected properties associated with the network elements are displayed in an integrated view along with the network layout. With the properties visually indicated in an integrated view, the operator can tell quickly at a glance the important properties associated with each network element without having to toggle among network element icons, as in the case with the prior art. Furthermore, the integrated view permit the operator to rapidly ascertain, during network configuration time, the properties associated with network elements other than the network element undergoing configuration. As mentioned, the properties associated with a given network element undergoing configuration may vary depending on the properties of other network elements that may interact with it. Accordingly, the ability to quickly ascertain the properties of other network elements in a private network allows the operator to more rapidly and accurately configure a given network element.

In the utility network context, this feature is particularly important. If the properties of a network element is incorrectly configured, and the error can only be ascertained when the properties of that network element are viewed in context of the properties accorded to other network elements, the ability to view the entire logical network, its network elements, and the properties associated with the network elements all in a single integrated GUI is almost a necessity for error analysis and error correction purposes.

In one embodiment, a network element icon may have a default visual appearance, which signifies a default property. As the operator selects a network element icon for configuration, the properties available to that network element is displayed for selection. Once the operator selects the property or properties, the visual appearance of the network element icon changes to reflect the properties newly selected for the associated network element.

The visual change to the network element icon may include, for example, the addition and/or deletion of a visual element, a change in color, shading, texture, background color, shape, text, and/or size. Furthermore, labeling in the form of text may also be employed to indicate the properties selected in the integrated view. If desired, various formats may be applied to the textual label to indicate different properties. Note that the visual indicator for the property or properties may represent an additional element on the display screen, or the same network element icon with a different visual appearance than the default network element icon.

In one embodiment, the operator may designate only some of the selected properties to be visually indicated in the integrated view. This may be useful in cases where a network element may have multiple selected properties, and the operator may not wish to crowd the integrated view with all the selected properties. In this embodiment, certain properties may have an option, which the operator can employ to indicate whether a selected property would be visually indicated in the integrated view. The operator may then designate as few or as many of the properties to be visually indicated as desired.

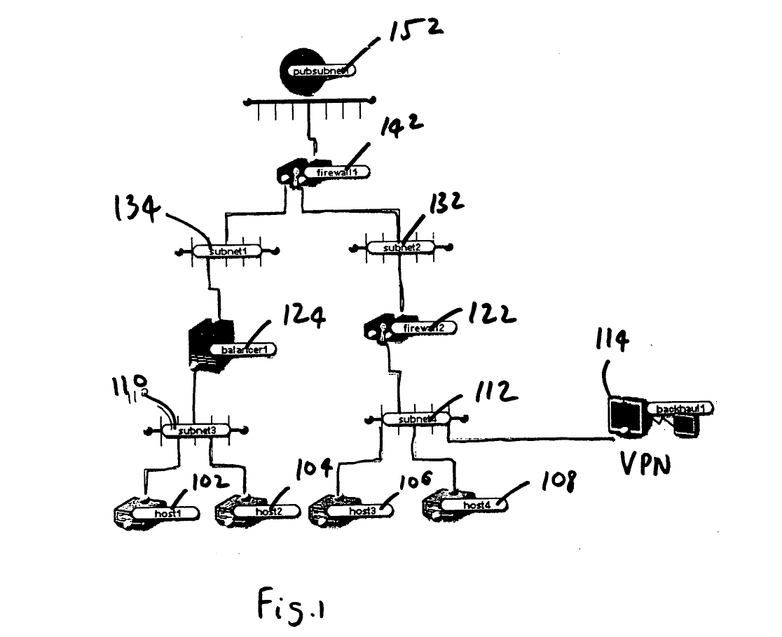

The features and advantages of the present invention may be better understood with reference to the figures and drawings that follow. FIG. 1 is a prior art illustration of a logical network topology rendered in a graphical user interface (GUI) computer screen, in which there are four hosts 102, 104, 106, and 108. Note that only the relevant portion of the GUI screen is shown in FIG. 1; other portions have been omitted for ease of illustration.

Hosts 102 and 104 are connected to a subnet 110, while hosts 106 and 108 are connected to a subnet 112. Subnet 112 is also connected to a virtual private network (VPN) 114 and firewall 122 as shown. Firewall 122 is in turn connected to a subnet 132. Subnet 110 is connected to a load balancer 124, which is in turn connected to a subnet 134. A firewall 142 is disposed between and connect subnets 132 and 134 with a public subnet 152.

Although not seen in FIG. 1, the various network element icons of FIG. 1 have associated properties. These properties may be viewed by right clicking on the network element icon. The right clicking action results in a pop-up screen (not shown) in which the properties associated with the selected network element are displayed, along with the status for each property (i.e., whether a particular property is selected for that network element icon). However, in the control console view of FIG. 1, these properties cannot be seen.

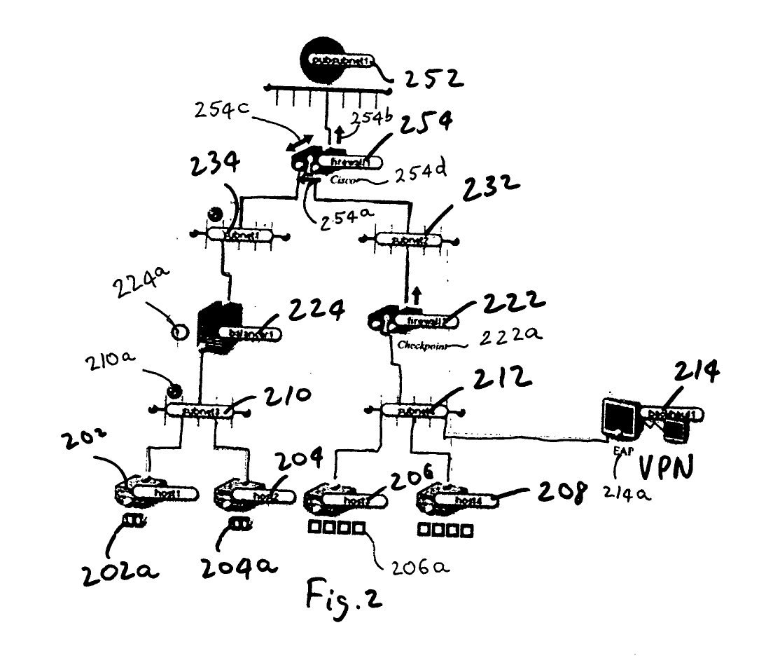

FIG. 2 shows, in accordance with one embodiment of the present invention, the integrated GUI control console view. In the integrated GUI view of FIG. 2, the same logical network as that represented by the prior art GUI control console view of FIG. 1 is depicted. However, each network element icon in FIG. 2 includes one or more visual indicators to indicate the properties selected. For example, hosts 202 and 204 include respective visual indicators 202a and 204a to indicate that the associated backup policy is nightly backup. Host 206 includes a visual indicator 206a (which is longer visually than visual indicator 202a in the example of FIG. 2) to indicate that the associated backup policy is weekly.

Subnet 210 has a visual indicator 210a (in the form of a globe icon in the example of FIG. 2) to indicate that it is public routable, while subnet 212 without any visual indication, thereby implicitly indicating that it is private. Load balancer 224 is associated with a visual indicator 224a (in the form of a little circle in the example of FIG. 2) to indicate that its policy is Round Robin. Firewall 254 has a plurality of arrow-shaped visual indicators to indicate the permitted accesses (254a from subnet 232 to subnet 234, 254b from subnet 232 to public subnet 252, and 254c between subnet 234 and public subnet 252). Each firewall in FIG. 2 also has an additional visual indicator to indicate the brand. Firewall 254 is indicated by a visual indicator 254d to be a Cisco firewall, and firewall 222 is indicated by a visual indicator 222a to be a Checkpoint firewall. VPN 214 has the text visual indicator 214a to indicate that it employs the protocol EAP.

Note that the visual indicator is displayed in a visually connected manner with its respective network element icon. In the example of FIG. 2, the visual connection is done by placing the visual indicator in close proximity to its respective network element icon. However, other ways to visually indicate a connection, such as an arrow, a line, or other techniques of visual association, may well be employed. If two or more network elements have properties that can be visually indicated, the visual indications for the properties for the multiple networks elements would be displayed simultaneously in a visually connected manner with the displayed network element icons, and the visual indications are preferably in the same window of the GUI display. However, it is possible to also provide windows visually connected to some or all of the network element icons to allow the properties for the multiple network elements to be visually indicated simultaneously on the GUI display.

Even the absence of a visual indicator may also be used to indicate certain property. For example, the absence of a visual indicator may be used to implicitly signify that the associated network element icon is associated with a certain property.

With the integrated GUI view of FIG. 2, the operator can tell quickly at a glance the relevant properties associated with each network element. This feature vastly simplifies and speeds up the trouble-shooting process should there exist an error caused by incorrect network element configuration. Since speed is of the essence in the competitive utility computing market, the integrated GUI feature offers lessors of utility computers a competitive advantage.

Furthermore, during network configuration time, the operator may quickly ascertain the properties of other network elements (e.g., hosts 202 and 204 via associated visual indicators 202a and 204a) and may employ the information to more quickly ascertain the properties to be accorded to a given network element (load balancer 224, for example).

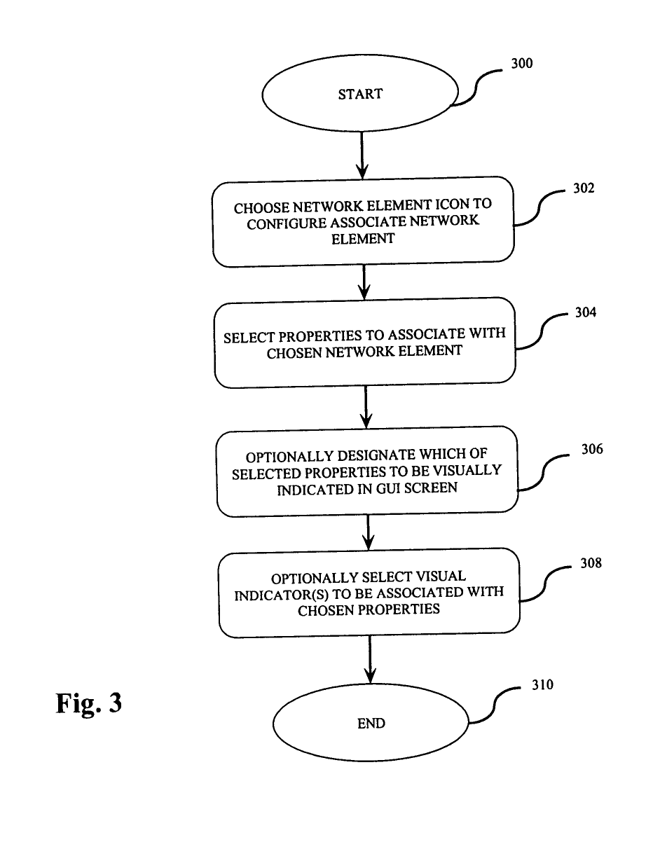

FIG. 3 is a flowchart illustrating the steps employed to configure a network element in accordance with one embodiment of the present invention. In step 302, the operator selects a network element icon to configure the associated network element. The selection of a network element icon may be accomplished using any pre-defined mouse or input device input gesture, e.g., right clicking. This network element icon may be previously placed into the integrated GUI area by a drag-and-drop operation from a palette, for example.

In step 304, the operator selects properties to be associated with the network element whose network element icon was selected in step 302. Multiple properties may be selected if desired.

In step 306, the operator may optionally designate which of the properties selected in step 304 would be visually indicated in the integrated GUI view. This optional step may be useful in situations wherein it is undesirable to crowd the integrated view with less relevant property visual indicators. Of course some properties may be designated such that they are always visually indicated in the integrated GUI view if selected.

In step 308, the operator may optionally select the visual indicator to be associated with the chosen properties. Generally speaking, each property is associated with a respective default visual indicator, but the operator may change the visual indicator associated with a given property if desired.

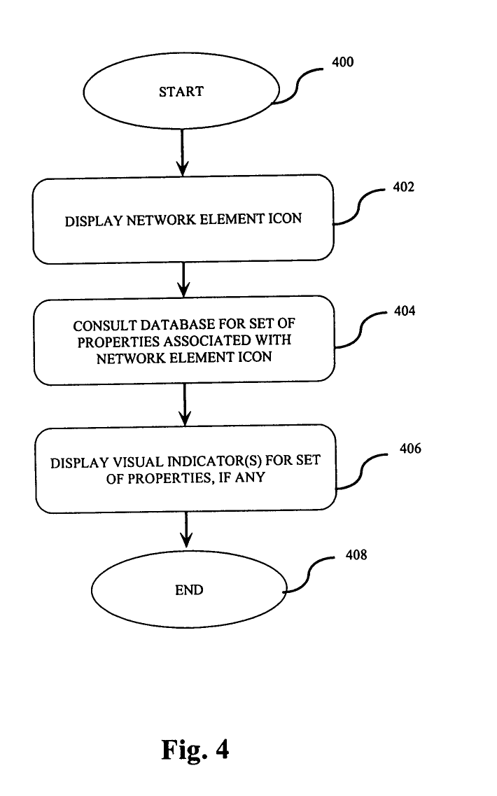

FIG. 4 is a flowchart illustrating, in accordance with one embodiment of the present invention, the steps taken when rendering a network element icon with associated property visual indicator(s). In step 402, the network element icon is displayed. Generally speaking, the list of network elements associated with a given logical network may be stored in a file, and the network element icons therefore may be displayed on the console for viewing by the operator. In step 404, a database is consulted to ascertain the set of properties selected for the network element icon displayed in step 402, and if there is one or more properties selected in the set, whether those selected properties should be displayed in the form of property visual indicators in the integrated GUI view. In step 406, the property visual indicators associated with the properties that have been selected and designated to be displayed are rendered in the integrated GUI view.

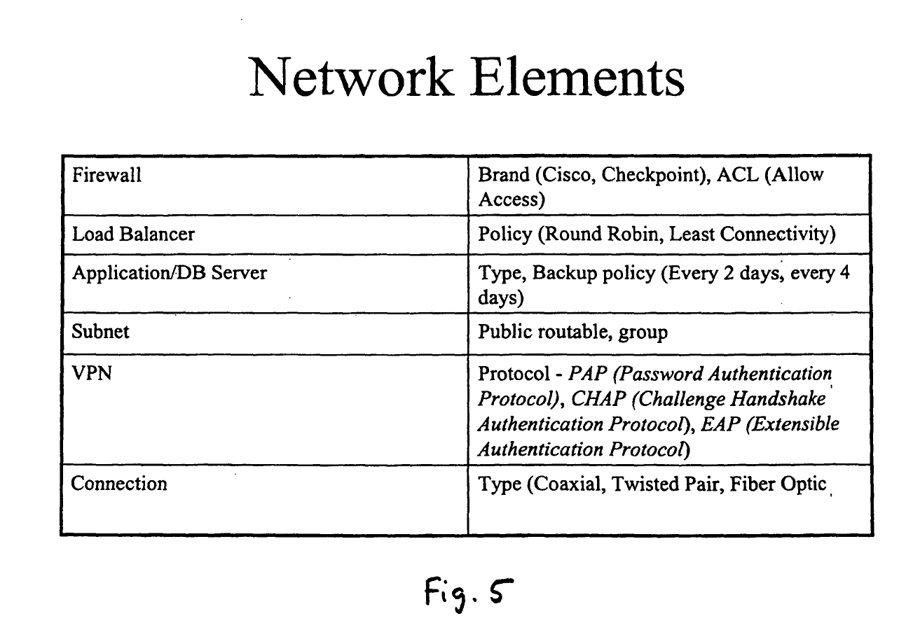

FIG. 5 is a table illustrating, in accordance with one embodiment, some exemplary network elements and their potential associated properties.

As can be appreciated from the foregoing, the integrated GUI view of the present invention, with its integrated property visual indicators for the network element icons, permit the operator to quickly at a glance the important properties associated with each network element. If the properties associated with a network element is erroneously configured, this error can be quickly discovered from the integrated GUI view. The speed advantage offered by the present invention is particularly important in the competitive utility computing market since customers associate extended down time with poor customer service, which affects the marketability of the utility computing service and customer satisfaction. Furthermore, since properties to be associated with a network element may be determined by the properties associated with other network elements of the logical network, the ability to quickly ascertain the properties of other network elements in a private network allows the operator to more rapidly and accurately configure a particular network element in the network.

While this invention has been described in terms of several preferred embodiments, there are alterations, permutations, and equivalents which fall within the scope of this invention. It is therefore intended that the following appended claims be interpreted as including all such alterations, permutations, and equivalents as fall within the true spirit and scope of the present invention.

1. A method for displaying a communication network in a graphical user interface (GUI) display, comprising:
displaying at least a portion of said communication network in said GUI display, including a plurality of network element icons representing a plurality of network elements and logical connections among said plurality of network element icons;
ascertaining a first set of properties associated with a first network element of said plurality of network elements, said first set of properties representing properties associated with said first network element in said communication network; and
displaying at least one visual indicator in said GUI display, said at least one visual indicator being displayed in a visually connected manner with a first network element icon representing said first network element, said at least one visual indicator visually indicating in said GUI display that said first set of properties is associated with said first network element in said communication network.

2. The method of claim 1 wherein said at least one visual indicator includes a visual icon other than said first network element icon.

3. The method of claim 1 wherein said at least one visual indicator includes a different color for said first network element icon said different color being different from a default color that exists if said first set of properties is not associated with said first network element in said communication network.

4. The method of claim 1 wherein said at least one visual indicator includes a different shading for said first network element icon, said different shading being different from a default shading that exists if said first set of properties is not associated with said first network element in said communication network.

5. The method of claim 1 wherein said at least one visual indicator includes a different background color for said first network element icon, said different background color being different from a default background color that exists if said first set of properties is not associated with said first network element in said communication network.

6. The method of claim 1 wherein said at least one visual indicator includes textual information pertaining to said first network element icon, said textual information being different from textual information, if any, that exists if said first set of properties is not associated with said first network element in said communication network.

7. The method of claim 1 wherein said at least one visual indicator includes a different texture for said first network element icon, said texture being different from a default texture that exists if said first set of properties is not associated with said first network element in said communication network.

8. The method of claim 1 wherein said at least one visual indicator represents a different shape for said first network element icon, said different shape being different from a default shape that is displayed if said first set of properties is not associated with said first network element in said communication network.

9. The method of claim 1 wherein said at least one visual indicator represents a different size for said first network element icon, said different size being different from a default size that is displayed if said first set of properties is not associated with said first network element in said communication network.

10. The method of claim 1 wherein said first network element is one of a server, a subnet, a firewall, a VPN and a load balancer.

11. The method of claim 1 further including
ascertaining a second set of properties associated with a second network element of said plurality of network elements, said second set of properties representing properties associated with said second network element in said communication network; and
displaying at least another visual indicator in said GUI display, said at least another visual indicator being displayed in a visually connected manner with a second network element icon representing said second network element, said at least another visual indicator visually indicating in said GUI display that said second set of properties is associated with said second network element in said communication network.

12. The method of claim 1 wherein said communication network represents a logical network constructed from a common pool of network elements.

13. A method for displaying a communication network in a graphical user interface (GUI) display, comprising:
displaying at least a portion of said communication network in said GUI display, including a plurality of network element icons representing a plurality of network elements and logical connections among said plurality of network element icons;
ascertaining a first set of properties associated with a first network element of said plurality of network elements, said first set of properties representing properties associated with said first network element in said communication network;
ascertaining a second set of properties associated with a second network element of said plurality of network elements, said second set of properties representing properties associated with said second network element in said communication network;
visually indicating in said GUI display that said first set of properties is associated with said first network element in said communication network; and
visually indicating in said GUI display, simultaneously with said visually indicating that said first set of properties is associated with said first network element, that said second set of properties is associated with said second network element in said communication network.

14. The method of claim 13 wherein said at least one visual indicator includes a visual icon other than said first network element icon.

15. The method of claim 13 wherein said visually indicating that said first set of properties is associated with said first network element and said visually indicating said second set of properties is associated with said second network element in said communication network occur in the same window of said GUI display.

16. The method of claim 15 wherein said at least one visual indicator includes a visual icon other than said first network element icon.

17. The method of claim 15 wherein said at least one visual indicator includes a different color for said first network element icon said different color being different from a default color that exists if said first set of properties is not associated with said first network element in said communication network.

18. The method of claim 15 wherein said at least one visual indicator includes a different shading for said first network element icon, said different shading being different from a default shading that exists if said first set of properties is not associated with said first network element in said communication network.

19. The method of claim 15 wherein said at least one visual indicator includes a different background color for said first network element icon, said different background color being different from a default background color that exists if said first set of properties is not associated with said first network element in said communication network.

20. The method of claim 15 wherein said at least one visual indicator includes textual information pertaining to said first network element icon, said textual information being different from textual information, if any, that exists if said first set of properties is not associated with said first network element in said communication network.

21. The method of claim 15 wherein said at least one visual indicator includes a different texture for said first network element icon, said texture being different from a default texture that exists if said first set of properties is not associated with said first network element in said communication network.

22. The method of claim 15 wherein said at least one visual indicator represents a different shape for said first network element icon, said different shape being different from a default shape that is displayed if said first set of properties is not associated with said first network element in said communication network.

23. The method of claim 15 wherein said at least one visual indicator represents a different size for said first network element icon, said different size being different from a default size that is displayed if said first set of properties is not associated with said first network element in said communication network.

24. The method of claim 15 wherein each of said first network element and said second network element is one of a server, a subnet, a firewall, a VPN and a load balancer.

25. The method of claim 24 wherein said communication network represents a logical network constructed from a common pool of network elements.

26. An article of manufacture comprising a program storage medium having computer readable code embodied therein, said computer readable code being configured to display a communication network in a graphical user interface (GUI) display, comprising:
computer readable code for displaying at least a portion of said communication network in said GUI display, including a plurality of network element icons representing a plurality of network elements and logical connections among said plurality of network element icons;
computer readable code for ascertaining a first set of properties associated with a first network element of said plurality of network elements, said first set of properties representing properties associated with said first network element in said communication network and for ascertaining a second set of properties associated with a second network element of said plurality of network elements, said second set of properties representing properties associated with said second network element in said communication network;
computer readable code for visually indicating in said GUI display that said first set of properties is associated with said first network element in said communication network and for visually indicating in said GUI display, simultaneously with said visually indicating that said first set of properties is associated with said first network element, that said second set of properties is associated with said second network element in said communication network.

27. The article of manufacture of claim 26 wherein said at least one visual indicator includes a visual icon other than said first network element icon.

28. The article of manufacture of claim 26 wherein said visually indicating that said first set of properties is associated with said first network element and said visually indicating said second set of properties is associated with said second network element in said communication network occur in the same window of said GUI display.

29. The article of manufacture of claim 28 wherein said at least one visual indicator includes a visual icon other than said first network element icon.

30. The article of manufacture of claim 28 wherein said visually indicating said first set of properties includes displaying a visual characteristic for said first network element icon said visual characteristic being different from a default visual characteristic that exists if said first set of properties is not associated with said first network element in said communication network, said visual characteristic representing one of a color for said first network element icon, a different shading for said first network element icon, a different background color for said first network element icon, a different texture for said first network element icon, textual information pertaining to said first network element, a different shape for said first network element icon, and a different size for said first network element icon.

31. The article of manufacture of claim 28 wherein each of said first network element and said second network element is one of a server, a subnet, a firewall, a VPN and a load balancer.

32. The article of manufacture of claim 28 wherein said communication network represents a logical network constructed from a common pool of network elements.
